(19) United States
(12) Patent Application Publication
(10) Pub. No.: US 2011/0311436 A1
(43) Pub. Date: Dec. 22, 2011

(54) METHOD FOR PRODUCING SPINEL-TYPE LITHIUM MANGANATE

(75) Inventors: Yukinobu YURA, Nagoya-city (JP); Nobuyuki KOBAYASHI, Nagoya-city (JP); Tsutomu NANATAKI, Toyoake-city (JP); Kazuyuki KAIGAWA, Kitanagoya-city (JP); Kei SATO, Tokai-city (JP)

(73) Assignee: NGK Insulators, Inc., Nagoya-City (JP)

(21) Appl. No.: 13/165,276

(22) Filed: Jun. 21, 2011

Related U.S. Application Data
(60) Provisional application No. 61/375,395, filed on Aug. 20, 2010.

(30) Foreign Application Priority Data
Jun. 21, 2010 (JP) PCT/JP2010/060927

(51) Int. Cl. C01D 15/00

(52) U.S. Cl. 423/599

(57) ABSTRACT

The production method of the present invention includes a raw material preparation step of preparing a raw material mixture; a firing step of firing the raw material mixture prepared through the raw material preparation step; and a crushing step of crushing the fired compact obtained through the firing step, wherein the raw material mixture contains a main raw material containing at least a manganese compound, and a seed crystal having a spinel-type crystal structure.

### BACKGROUND OF THE INVENTION

1. Field of the Invention

The present invention relates to a method for producing spinel-type lithium manganate, which is an oxide containing at least lithium and manganese as constituent elements and having a spinel structure.

2. Description of the Related Art

Such spinel-type lithium manganate is known as a cathode active material for a lithium secondary battery (may be referred to as a “lithium ion secondary battery”) (see, for example, Japanese Patent Application Laid-Open (kokai) Nos. H11-171551, 2000-30707, 2006-252940, and 2007-294119). In contrast to a cathode active material formed of a cobalt oxide or a nickel oxide, a cathode active material formed of spinel-type lithium manganate has the following features: high safety, high rate characteristics, and low cost.

### SUMMARY OF THE INVENTION

However, spinel-type lithium manganate cathode active material poses problems in terms of durability, including deterioration of cycle characteristic at high temperature, and deterioration of storage characteristics at high temperature. An effective approach to solve such a problem is, for example, formation of large-sized cathode active material particles of spinel-type lithium manganate (e.g., formation of particles having a size of 10 μm or more) (see, for example, paragraph [0005] of Japanese Patent Application Laid-Open (kokai) No. 2003-109592).

Upon production of cathode active material particles of spinel-type lithium manganate, generally, grain growth is promoted through firing at high temperature, whereby large-sized particles are obtained. When firing is carried out at excessively high temperature, spinel-type lithium manganate releases oxygen and is decomposed into lithium manganate having a layered rock salt structure, and manganese oxide. During temperature drop, the thus-decomposed substances absorb oxygen and are restored to spinel-type lithium manganate. However, particles which have undergone such a process have many oxygen defects, resulting in deterioration of characteristics (e.g., cell capacity).

As shown in scanning electron micrographs (SEMs) described in Japanese Patent Application Laid-Open (kokai) No. 2007-294119, spinel-type lithium manganate single-crystal particles produced through the production method disclosed in the patent document have a wide particle size distribution and contain a large amount of fine powder. In addition, many particles form aggregates, and the amount of primary particles (i.e., crystalline particles which do not form aggregates and are present singly; may also be referred to as “single particles”) is small. Therefore, a cathode active material layer may fail to be filled with such conventional particles at high level (density). In the case of such particles, migration of lithium ions is prevented by grain boundaries, and thus high rate characteristic is difficult to attain.

Thus, conventional methods have failed to industrially (i.e., stably) produce spinel-type lithium manganate particles which are suitable for use as a cathode active material for a lithium secondary battery, which exhibit excellent characteristics, and which exhibit high durability.

As used herein, “spinel-type lithium manganate, which is an oxide containing at least lithium and manganese as constituent elements and having a spinel structure,” which is produced through the method of the present invention, is not limited to that represented by the formula LiMn₂O₄. Specifically, the present invention is suitably applied to a compound represented by the following formula (1) and having a spinel structure.

LiMₓMn₂₋ₓO₄ (1)

In formula (1), M represents at least one element (substitution element) selected from the group consisting of Li, Fe, Ni, Mg, Zn, AI, Co, Cr, Si, Sn, P, V, Sb, Nb, Ta, Mo, and W. The substitution element M may include Ti, Zr, or Ce in addition to the aforementioned at least one element.

In formula (1), x (0 to 0.55) corresponds to the proportion of the substitution element M. Li is a monovalent cation; Fe, Mn, Ni, Mg, or Zn is a divalent cation; B, Al, Co, or Cr is a trivalent cation; Si, Ti, Sn, Zr, or Ce is a tetravalent cation; P, V, Sb, Nb, or Ta is a pentavalent cation; and Mo or W is a hexavalent cation. Theoretically, any of these elements forms a solid solution with LiMn₂O₄.

When, for example, M is Li, and x is 0.1, the compound of formula (1) is represented by the following chemical formula (2). When M is Li and Al (M1=Li, M2=Al), and x is 0.08 and 0.09 (i.e., x1[Li]=0.08, x2[Al]=0.09), the compound of formula (1) is represented by the following chemical formula (3).

Li_{1.1}Mn_{1.9}O₄ (2)

Li_{1.08}Al_{0.09}Mn_{1.83}O₄ (3)

Co or Sn may be a divalent cation; Fe, Sb, or Ti may be a trivalent cation; Mn may be a trivalent or tetravalent cation; and Cr may be a tetravalent or hexavalent cation. Therefore, the substitution element M may have a mixed valency. The atomic proportion of oxygen is not necessarily 4. So long as the compound of formula (1) can maintain a crystal structure, the atomic proportion of oxygen may be less than or greater than 4.

Substitution of 20 to 55 mol % of Mn by Ni, Co, Fe, Cu, Cr, etc. realizes production of a cathode active material which can be employed for producing a lithium secondary battery exhibiting excellent high-temperature cycle characteristic and rate characteristic. Also, in such a case, energy density can be increased by elevating charge/discharge potential, and thus a lithium secondary battery having an electromotive force as high as 5 V can be produced.

Thus, spinel-type lithium manganate which is produced through the method of the present invention has a spinel structure and is represented by the following formula (4):

Li₁₊ₐM_{y}Mn_{2-a-y}O_{4-σ} (4)

(wherein 0≦y≦0.5, 0≦a≦0.3, 0≦σ≦0.05).

The production method of the present invention comprises: (A) a raw material preparation step of preparing a raw material mixture of a main raw material containing at least a manganese compound (a compound of elements (other than oxygen) included in formula (4)), and a seed crystal having the same crystal structure as the fired compact obtained through the below-described firing step; (B) a firing step of firing the raw material mixture prepared through the raw material preparation step; and (C) a crushing step of crushing the fired compact obtained through the firing step.

No particular limitation is imposed on the aforementioned seed crystal, so long as it has the same crystal structure as the aforementioned fired compact; i.e., spinel-type lithium manganate which is produced through the production method of the present invention. That is, the seed crystal does not necessarily have the same composition as the fired compact or spinel-type lithium manganate which is produced through the production method (but the seed crystal preferably has a composition identical with or as similar as possible to that of the fired compact). Specifically, the main raw material may contain a lithium compound and a manganese compound.

The production method of the present invention may further comprise (D) a forming step of forming the aforementioned raw material mixture into a thin compact (e.g., a sheet-like, tape-like, hollow, longitudinally elongated rod-like, acicular, or fibrous compact) before the firing step is carried out.

According to the production method of the present invention, which includes the aforementioned steps, the aforementioned main raw material is well mixed with the aforementioned seed crystal in the raw material preparation step, and the seed crystal, which serves as a nucleus for grain growth in the subsequent firing step, is dispersed in the raw material mixture as uniformly as possible. Thus, appropriate optimization of addition of the seed crystal realizes stable production of a fired compact of spinel-type lithium manganate particles having a certain particle size which is as uniform as possible.

When, for example, the aforementioned fired compact contains relatively large-sized grains and fine grains, and has a bimodal structure in which these types of grains are three-dimensionally bonded to one another, a very strong force must be applied for crushing of the fired compact in the crushing step. Therefore, the resultant spinel-type lithium manganate particles exhibit low crystallinity and deteriorated characteristics, due to large stress applied to the fired compact in the crushing step. In contrast, according to the production method of the present invention, formation of such fine grains in the fired compact is reduced to a minimum possible extent. Therefore, the fired compact can be readily crushed without application of strong force, and deterioration of crystallinity, which would otherwise be caused by crushing, is suppressed. The thus-obtained spinel-type lithium manganate particles exhibit favorable characteristics:

From the viewpoint of production of the aforementioned large-sized cathode active material particles of spinel-type lithium manganate, the seed crystal preferably has a median particle size of 0.1 to 10 μm, more preferably 1 to 6 μm. The seed crystal preferably has a density of 1×10⁸ to 1×10¹¹ particles/cm³ fired compact, more preferably 1.5×10⁸ to 2.4×10¹⁰ particles/cm³ fired compact. The amount of the seed crystal added is preferably 25 wt. % or less with respect to the fired compact.

When the particle size of the seed crystal or the amount of the seed crystal added is excessively small, the aforementioned grain growth which starts from the seed crystal becomes insufficient, whereas when the particle size of the seed crystal or the amount of the seed crystal added is excessively large, the above-described effective grain growth is prevented.

When a thin compact formed through the forming step is fired in the firing step, since the amount of the raw material of the compact is very low in a thickness direction (in a shell thickness direction in the case where the compact has a hollow structure, or in a thickness direction in the case where the compact has a shape elongated in a longitudinal direction (e.g., a rod-like, acicular, or fibrous compact)), a limitation is imposed on the grain growth in a thickness direction (i.e., no increase in thickness of the compact is observed upon grain growth). Thus, in the firing step, grain growth proceeds until a single crystal grain is completed in a thickness direction of the compact. In parallel therewith, grain growth proceeds in an in-plane direction orthogonal to a thickness direction or in a longitudinal direction, but the grown grain has a size not greatly exceeding the thickness of the compact. Thus, the particle size of the compact can be controlled by the thickness of the compact. No grain boundaries are formed in a thickness direction of the fired compact, and the fired compact can be effectively crushed into primary particles.

When the aforementioned compact has an elongated shape, upon growth of a certain crystal grain, other (adjacent) grains are present only along a longitudinal direction. Therefore, when the crystal grain has a cubic shape, only two faces of the crystal grain (i.e., two faces which are generally orthogonal to a longitudinal direction and are aligned along the longitudinal direction) are interactive with the other adjacent grains, and the crystal grain has four free faces (i.e., faces which are not interactive with the other grains). Thus, the number of free faces of a crystal grain is larger, as compared with the case where the aforementioned compact has another shape (e.g., bulky, thin, polyhedral, or spherical). Therefore, crystal grains having euhedral shapes (intrinsic shapes formed through free growth of crystals) and good crystallinity can be effectively formed. The fired compact can be effectively crushed into primary particles at grain boundaries aligned along a longitudinal direction.

When, for example, cubic crystal grains are arranged in series in a longitudinal direction, each grain is interactive with other adjacent grains at two faces (grain boundaries); i.e., crushing is performed at the two faces. In contrast, when, for example, cubic crystal grains are arranged on the left, right, top and bottom, each grain is interactive with other adjacent grains at six faces (grain boundaries); i.e., crushing is performed at the six faces. In the former case (corresponding to the present invention), energy for crushing can be reduced as compared with the latter case, and thus particles (powder) obtained through crushing exhibit high crystallinity. Therefore, when the thickness (R) of the aforementioned compact is adjusted to, for example, about 7 to about 30 large-sized particles exhibiting excellent characteristics are effectively produced.

The aforementioned raw material mixture may further contain a grain growth promoting aid having a melting point lower than the firing temperature employed in the firing step. When such a grain growth promoting aid is contained in the raw material mixture, in the firing step, grain growth starts from the seed crystal, and the low-melting-point grain growth promoting aid is melted, to thereby form a flux. Such a flux may be formed together with the main elements of the main raw materials (i.e., lithium, manganese, oxygen, and the substitution element M included in formula (4)). Thus, grain growth is effectively promoted. Furthermore, since a grain boundary phase is formed by the flux while the seed crystal is uniformly dispersed, abnormal grain growth is suppressed, and the resultant crystal grains have a size as uniform as possible.

Since the grain boundary phase remaining in the fired compact obtained through the firing step exhibits low strength and corrosion resistance, the fired compact is readily crushed into primary particles through the subsequent crushing step. The remaining grain boundary phase can be effectively removed through a simple cleaning step without causing deterioration in crystallinity. Therefore, relatively large-sized primary particles exhibiting favorable characteristics and durability and having uniform particle size are produced at high yield.

From this viewpoint, the amount of the aforementioned grain growth promoting aid added is preferably 5 wt. % or less. When the amount of the aid exceeds 5 wt. %, difficulty is encountered in removing a component of the aid (the aforementioned grain boundary phase), and the resultant particles may fail to be employed as cathode active material particles for a lithium secondary battery.

When only the aforementioned grain growth promoting aid is added without addition of the seed crystal, the resultant fired compact may have a bimodal microstructure as described above. In contrast, according to the production method of the present invention, formation of such a bimodal structure can be effectively prevented.

Thus, the production method of the present invention can industrially (i.e., stably) produce spinel-type lithium manganate particles which are suitable for use as a cathode active material for a lithium secondary battery, which exhibit excellent characteristics, and which exhibit high durability.

### BRIEF DESCRIPTION OF THE DRAWINGS

FIG. 1 Sectional view of the schematic configuration of an example lithium secondary battery to which one embodiment of the present invention is applied.

FIG. 2 Perspective view of the schematic configuration of another example lithium secondary battery to which one embodiment of the present invention is applied.

FIG. 3 Enlarged sectional view of the cathode plate shown in FIG. 1 or 2.

FIG. 4A Scanning electron micrograph of a surface of a thin fired compact formed through the forming step and the firing step of the production method of the present invention.

FIG. 4B Scanning electron micrograph of a surface of a thin fired compact formed through a conventional method without addition of a seed crystal.

FIG. 5 Side sectional view of the schematic configuration of a coin cell for evaluating spinel-type lithium manganate particles (cathode active material particles shown in FIG. 3) produced through one embodiment of the production method of the present invention.

### DETAILED DESCRIPTION OF THE PREFERRED EMBODIMENTS

Preferred embodiments of the present invention will next be described with reference to examples and comparative examples. The following description of the embodiments is nothing more than the specific description of mere example embodiments of the present invention to the possible extent in order to fulfill description requirements (descriptive requirement and enabling requirement) of specifications required by law.

Thus, as will be described later, naturally, the present invention is not limited to the specific configurations of embodiments and examples to be described below. Modifications that can be made to the embodiments and examples are collectively described herein at the end to a maximum possible extent, since insertion thereof into the description of the embodiments would disturb understanding of consistent description of the embodiments.

### 1. Configuration of Lithium Secondary Battery

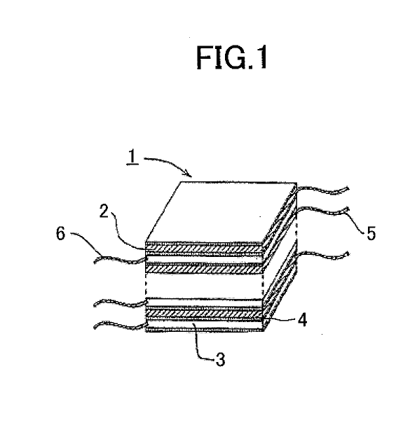

FIG. 1 is a sectional view of the schematic configuration of an example lithium secondary battery 1 to which one embodiment of the present invention is applied. Referring to FIG. 1, the lithium secondary battery 1 is a so-called liquid-type battery and includes cathode plates 2, anode plates 3, separators 4, cathode tabs 5, and anode tabs 6.

The separator 4 is provided between the cathode plate 2 and the anode plate 3. That is, the cathode plate 2, the separator 4, and the anode plate 3 are stacked in this order. The cathode tabs 5 are electrically connected to the respective cathode plates 2. Similarly, the anode tabs 6 are electrically connected to the respective anode plates 3.

The lithium secondary battery 1 shown in FIG. 1 is configured such that a stack of the cathode plates 2, the separators 4, and the anode plates 3, and an electrolytic solution containing a lithium compound as an electrolyte are liquid-tightly sealed in a specific cell casing (not illustrated).

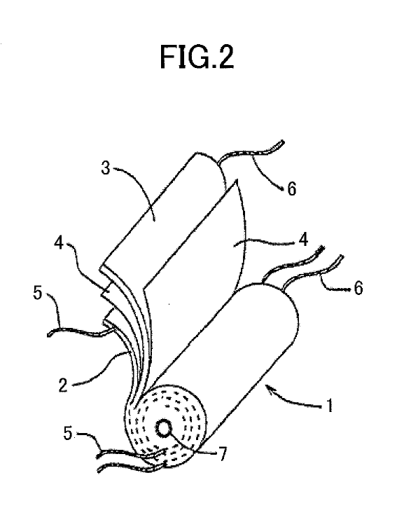

FIG. 2 is a perspective view of the schematic configuration of another example lithium secondary battery 1 to which one embodiment of the present invention is applied. Referring to FIG. 1, this lithium secondary battery 1 is also a liquid-type battery and includes a cathode plate 2, an anode plate 3, separators 4, cathode tabs 5, anode tabs 6, and a core 7.

The lithium secondary battery 1 shown in FIG. 2 is configured such that an internal electrode body formed through winding, onto the core 7, of a stack of the cathode plate 2, the separators 4, and the anode plate 3, and the aforementioned electrolytic solution are liquid-tightly sealed in a specific cell casing (not illustrated).

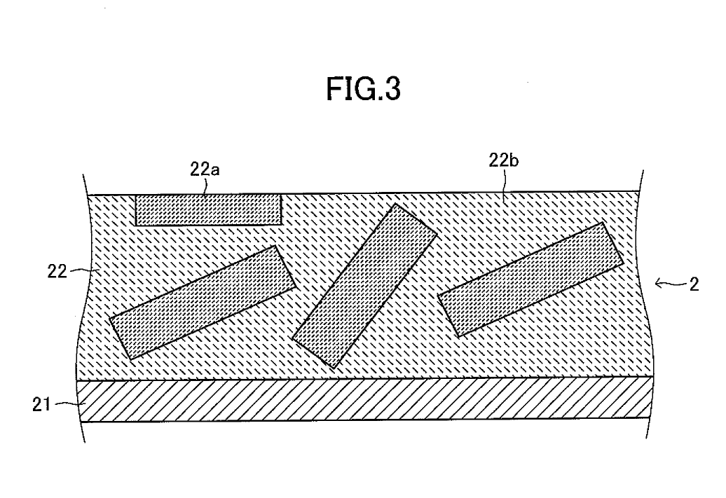

FIG. 3 is an enlarged sectional view of the cathode plate 2 shown in FIG. 1 or 2. Referring to FIG. 3, the cathode plate 2 includes a cathode current collector 21 and a cathode layer 22. The cathode layer 22 is configured such that cathode active material particles 22a are dispersed in a binder 22b. The cathode active material particles 22a are crystal particles (primary particles) of spinel-type lithium manganate having a large particle size (specifically, a maximum size of about 10 μm).

### 2. Method for Producing Cathode Active Material Particles

The cathode active material particles 22a shown in FIG. 3 are produced through a production method including the following three steps: (i) raw material preparation step, (ii) firing step, and (iii) crushing and classification step.

(i) Raw material preparation step: A raw material powder mixture containing at least a manganese compound and a seed crystal is prepared. The raw material powder mixture may contain a lithium compound or a grain growth promoting aid. The seed crystal or the grain growth promoting aid may be added at the time when powders of main raw materials (e.g., a lithium compound and a manganese compound) are mixed, or may be added after mixing of the main raw material powders.

When manganese is substituted by an element other than lithium, the raw material powder mixture contains, for example, an aluminum compound, a magnesium compound, a nickel compound, a cobalt compound, a titanium compound, a zirconium compound, or a cerium compound.

The lithium compound employed may be, for example, Li₂CO₃, LiNO₃, LiOH, Li₂O₂, Li₂O, CH₃COOLi, Li(OCH₃), Li(OC₂H₅), Li(OC₃H₇), Li(OC₄H₉), Li(C₁₁H₁₉O₂), Li₂C₂O₄, or LiCl. The manganese compound employed may be, for example, MnO₂, MnO, Mn₂O₃, Mn₃O₄, MnCO₃, MnOOH, Mn(OCH₃)₂, Mn(OC₂H₅)₂, Mn(OC₃H₇)₂, MnC₂O₄, Mn(CH₃COO)₂, MnCl₂, or Mn(NO₃)₂.

When manganese is substituted by an element other than lithium, the aluminum compound employed may be, for example, α-Al₂O₃, γ-Al₂O₃, AlOOH, Al(OH)₃, Al(OCH₃)₃, Al(OC₂H₅)₃, Al(OC₃H₇)₃, Al(OC₄H₉)₃, AlOCl, or Al(NO₃)₃. The magnesium compound employed may be, for example, MgO, Mg(OH)₂, MgCO₃, Mg(OCH₃)₂, Mg(OC₂H₅)₂, Mg(OC₃H₇)₂, Mg(OC₄H₉)₂, Mg(C₁₁H₁₉O₂)₂, MgCl₂, Mg(C₂H₃O₂)₂, Mg(NO₃)₂, or MgC₂O₄.

The nickel compound employed may be, for example, NiO, Ni(OH)₂, NiNO₃, Ni(C₂H₃O₂)₂, NiC₂O₄, NiCO₃, or NiCl₂. The cobalt compound employed may be, for example, CO₃O₄, CoO, Co(OH)₃, CoCO₃, CoC₂O₄, CoCl₂, Co(NO₃)₂, or Co(OC₃H₇)₂. The titanium compound employed may be, for example, TiO, TiO₂, Ti₂O₃, Ti(OCH₃)₄, TROC₂H₅)₄, Ti(OC₃H₇)₄, Ti(OC₄H₉)₄, or TiCl₄. The zirconium compound employed may be, for example, ZrO₂, Zr(OH)₄, ZrO(NO₃)₂, Zr(OCH₃)₄, Zr(OC₂H₅)₄, Zr(OC₃H₇)₄, Zr(OC₄H₉)₄, or ZrOCl₂. The cerium compound employed may be, for example, CeO₂, Ce(OH)₄, or Ce(NO₃)₃.

The grain growth promoting aid (flux aid or low-melting-point aid) employed may be, for example, a low-melting-point oxide, chloride, boride, carbonate, nitrate, hydroxide, oxalate, or acetate, an alkoxide, or a permanganate. The grain growth promoting aid may be added separately from the seed crystal, or may be added in the form of being bonded to the seed crystal. Both of these may be employed in combination. Preferably, both of these are added together. When the grain growth promoting aid is bonded to the seed crystal, grain growth of the seed crystal proceeds effectively from the point at which they are bonded to each other. Meanwhile, when the grain growth promoting aid is added separately from the seed crystal, grain growth proceeds to some extent at a portion where the seed crystal is absent, and abnormal grain growth of the seed crystal is suppressed. Thus, crystal grains having more uniform size are grown.

Specifically, the grain growth promoting aid employed may be any of the following: NaClO₃, Na₂B₄O₇, NaBO₂, Na₂CO₃, NaHCO₃, NaNO₃, NaOH, Na₂C₂O₄, NaOCH₃, NaOC₂H₅, NaOC₃H₇, NaOC₄H₉, KCl, K₂B₄O₇, K₂CO₃, KNO₃, KOH, K₂C₂O₄, KOCH₃, KOC₂H₅, KOC₃H₇, KOC₄H₉, K(C₁₁H₁₉O₂), CaCl₂, CaCO₃, Ca(NO₃)₂, Ca(OH)₂, CaC₂O₄, Ca(CH₃COO)₂.H₂O, Ca(OCH₃)₂, Ca(OC₂H₅)₂, Ca(OC₃H₇)₂, Ca(OC₄H₉)₂, Bi₂O₃, NaBiO₃, BiCl₃, BiOCl, Bi(NO₃)₃, Bi(OH)₃, Bi(OC₂H₅)₃, Bi(OC₃H₇), Bi(OC₅H₁₁)₃, Bi(C₆H₅)₃, Bi(C₁₁H₁₉O₂)₃, PbO, PbCl₂, PbB₂O₄, PbCO₃, Pb(NO₃)₂, PbC₂O₄, Pb(CH₃COO)₂, Pb(OC₃H₇)₂, Pb(C₁₁H₁₉O₂)₂, KMnO₄, NaMnO₄, Ca(MnO₄)₂, Bi₂Mn₄O₁₀, low-melting-point glass, etc.

The seed crystal formed of spinel-type lithium manganate, which serves as a nucleus for grain growth, has a particle size of 0.1 to 10 μm (preferably 1 to 6 μm). The seed crystal has a density of 1×10⁸ to 1×10¹¹ particles/cm³ fired compact (preferably 1.5×10⁸ to 2.4×10¹⁰ particles/cm³ fired compact). The amount of the seed crystal added is 25 wt. % or less with respect to the fired compact.

No particular limitation is imposed on the method for producing the seed crystal. For example, the seed crystal employed is preferably fine powder obtained by sieving of particles of intended size (cathode active material particles 22a) through the below-described classification step (in this case, a grain growth promoting aid may be bonded to the fine powder).

If necessary, main raw material powder of a lithium compound or a manganese compound may be crushed. The main raw material powder must have a particle size (median size) smaller than at least that of seed crystal particles, so that the seed crystal particles function as nuclei for grain growth. No particular limitation is imposed on the crushing method, and crushing may be carried out by means of, for example, a pot mill, a bead mill, a hammer mill, or a jet mill.

(ii) Forming step: A compact having an appropriate shape may be formed from the raw material powder mixture prepared through the aforementioned raw material preparation step. No particular limitation is imposed on the forming method, and, for example, a conventionally well known forming method may be employed. Specifically, a tape-like, sheet-like, or thin compact may be formed through, for example, any of the following forming methods:
doctor blade method;
screen printing;
drum dryer method (specifically, a slurry of raw material powder particles is applied onto a heated drum, and then the dried material is scraped off with a scraper);
disk dryer method (specifically, a slurry of raw material powder particles is applied onto a heated disk surface, and then the dried material is scraped off with a scraper); and
extrusion molding in which clay containing raw material powder particles is extruded through a nozzle having a slit. A formed compact obtained through any of the aforementioned forming methods may be further pressed with, for example, a roller, so as to increase the density of the compact.

Of these forming methods, the doctor blade method is preferred, since it can form a uniform sheet-like compact. In the doctor blade method, a slurry is applied onto a flexible plate (e.g., an organic polymer plate, such as a polyethylene terephthalate (PET) film), and the applied slurry is dried and solidified into a compact. Then, the compact is separated from the plate, to thereby form a green compact. Preferably, the slurry is prepared so as to have a viscosity of 500 to 4,000 mPa·s and is defoamed under reduced pressure.

A hollow particulate compact may be formed by appropriately regulating the conditions of a spray dryer. A particulate compact (bulky compact) having a size of 10 to 30 μm may be formed through, for example, spray drying, pressing of raw material powder particles by means of a roller, etc., or cutting of an extrusion-molded rod-like or sheet-like compact. A honeycomb or rod-like compact may be formed through, for example, extrusion molding. A roll-like compact may be formed through, for example, the drum dryer method.

A compact elongated in a longitudinal direction (i.e., a rod-like, acicular, or fibrous compact) may be formed through, for example, extrusion molding or gel cast molding. Preferably, this compact has an aspect ratio (L/R) (wherein L represents a longitudinal size, and R represents a maximum size (thickness) as measured in a direction perpendicular to the longitudinal direction (i.e., in a thickness direction)) of 3 or more, and a thickness R of about 7 to about 30 μm.

When extrusion molding is carried out, a wire-shaped compact extruded through a nozzle may be wound on, for example, a winding reel before drying. Also, the aforementioned elongated compact is obtained by cutting a primary compact into elongated pieces, the primary compact being formed through, for example, the doctor blade method or the drum dryer method. Alternatively, the aforementioned elongated compact is obtained by forming a sol precursor into a rod-like or fibrous shape, followed by gelation. In this case, a primary compact formed of the precursor may be wound on, for example, a winding reel before gelation.

(iii) Firing (thermal treatment) step: A raw material powder mixture prepared through the aforementioned raw material preparation step is fired (thermally treated) at 830 to 1,050° C. Through this step, the compact is formed into a fired compact of spinel-type lithium manganate (cathode active material). This firing step is carried out through, for example, the following procedure: a raw material powder mixture prepared through the aforementioned raw material preparation step is placed, as is, into a crucible or sagger made of alumina, and then the crucible or the sagger is placed in a furnace. When the aforementioned compact is placed in the crucible or the sagger upon firing, the compact may be subjected to a process (e.g., folding or cutting) in advance so that the compact has an appropriate length or shape.

When the firing temperature is lower than 830° C., grain growth may fail to proceed sufficiently, whereas when the firing temperature exceeds 1,050° C. (e.g., reaches about 1,100° C.), spinel-type lithium manganate may release oxygen and may be decomposed into lithium manganate having a layered rock salt structure, and manganese oxide.

Firing may be carried out in an oxygen atmosphere (high oxygen partial pressure) (in this case, the oxygen partial pressure is preferably, for example, 50% or more of the pressure of the firing atmosphere). In this case, spinel-type lithium manganate is less likely to release oxygen, and thus the above-described oxygen defects or decomposition is effectively suppressed. In the case where the aforementioned grain growth promoting aid or seed crystal is contained in the raw material, even when the firing temperature is relatively low (e.g., about 900° C.), grain growth is promoted, and thus improvement of crystallinity or similar effects are expected to be attained.

(iv) Crushing and classification step: A fired compact of spinel-type lithium manganate (cathode active material) obtained through the aforementioned firing step is subjected to wet or dry crushing and classification, to thereby produce powder of spinel-type lithium manganate (cathode active material) particles having an intended size.

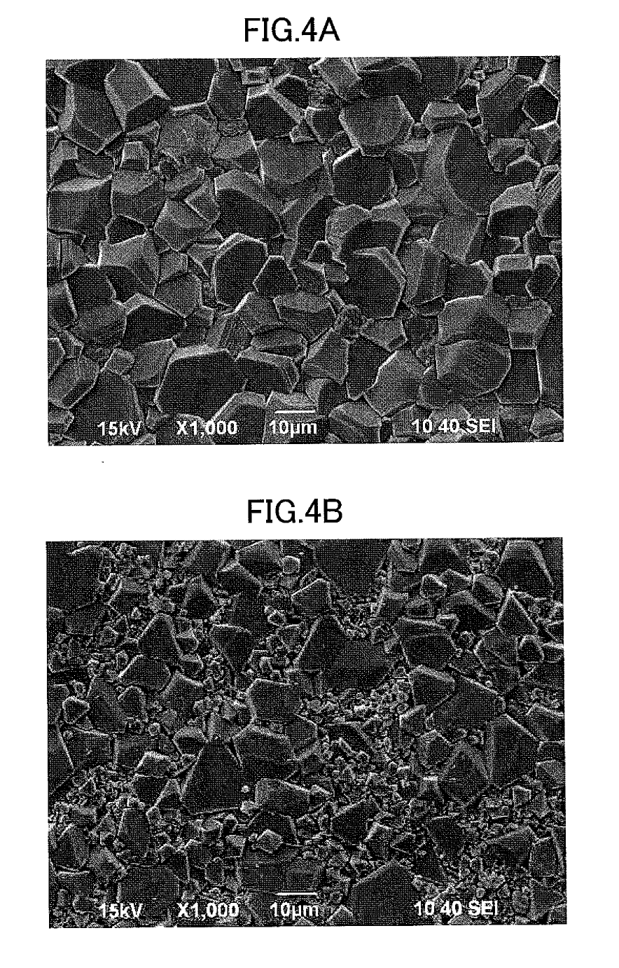

FIG. 4A is a scanning electron micrograph of a surface of the aforementioned fired compact (thin fired compact obtained through a sheet forming step). Meanwhile, FIG. 4B is a scanning electron micrograph of a surface of a thin fired compact obtained through a conventional method (no addition of a seed crystal).

As shown in FIG. 4B, the thin fired compact obtained through a conventional method (no addition of a seed crystal) contains large-sized grains (10 μm or more) and fine grains (5 μm or less) and has a bimodal structure in which these grains are three-dimensionally bonded to one another. Particularly, bonding strength is high at a portion where fine grains are bonded to one another, or at a portion where large-sized grains are bonded to such a fine-grain-bonded portion. Therefore, a very strong force must be applied for crushing of the conventional thin fired compact in the crushing step. Thus, the resultant spinel-type lithium manganate particles exhibit low crystallinity and deteriorated characteristics, due to large stress applied to the fired compact upon crushing.

In contrast, as shown in FIG. 4A, the fired compact produced through the production method according to the present embodiment contains virtually no fine grains. Therefore, the fired compact can be readily crushed without application of strong force, and deterioration of crystallinity, which would otherwise be caused by crushing, is suppressed. The thus-obtained spinel-type lithium manganate particles exhibit favorable characteristics.

No particular limitation is imposed on the crushing method, and crushing may be carried out by, for example, pressing the fired compact onto a mesh or screen having an opening size of 5 to 100 μm. Alternatively, crushing may be carried out by means of, for example, a pot mill, a bead mill, a hammer mill, or a jet mill. No particular limitation is imposed on the classification method, and classification may be carried out through, for example, elutriation or sieving by use of a mesh having an opening size of 5 to 100 μm. Alternatively, classification may be carried out by means of, for example, an airflow classifier, a sieve classifier, or an elbow jet classifier.

The thus-obtained particles of intended size may be subjected to thermal retreatment at a temperature lower than the aforementioned firing temperature (e.g., at 600 to 750° C. for 3 to 48 hours in air or an oxygen atmosphere). This thermal retreatment restores oxygen defects and crystallinity disturbed during crushing. The aforementioned thermal retreatment may be carried out before crushing (i.e., upon temperature drop in the first firing) by maintaining the fired compact at an intended temperature for a certain period of time, or by reducing a temperature lowering rate (e.g., 5 to 100 degrees (° C.)/h) from the firing temperature to an intended temperature (e.g., 600 to 750° C.). This thermal retreatment exerts the effect of restoring oxygen defects. When thermal retreatment is carried out after crushing (or after classification), the thus-retreated powder may be subjected to crushing or classification again. In this case, crushing or classification may be performed through, for example, the aforementioned method.

### 3. Specific Examples

Next will be described in detail specific examples of the above-described production method, and the results of evaluation of particles produced through the production methods of the specific examples.

3-1. Production Method

(i) Raw Material Preparation Step

Raw material powders of a lithium compound and a manganese compound were weighed so as to attain a specific composition. The thus-weighed materials and an organic solvent (a mixture of xylene and an equiamount of 1-butanol) serving as a dispersion medium were placed in a cylindrical wide-mouthed bottle made of a synthetic resin and subjected to mixing and crushing by means of a ball mill (zirconia balls having a diameter of 5 mm) until the particle size (median size) of the raw material powders became smaller than that of seed crystal particles employed. Thereafter, a grain growth promoting aid and the seed crystal were added in specific amounts (see the below-described tables) to the wide-mouthed bottle, followed by further mixing, to thereby prepare a raw material powder mixture.

(ii) Forming Step

The raw material powder mixture was mixed with polyvinyl butyral (trade name “S-lec BM-2,” product of Sekisui Chemical Co. Ltd.) serving as a binder (10 parts), a plasticizer (trade name “DOP”: di(2-ethylhexyl) phthalate, product of Kurogane Kasei Co., Ltd.) (4 parts), and a dispersant (trade name “Rheodol SP-030,” product of Kao Corporation) (2 parts), to thereby prepare a slurry material for forming. The thus-prepared slurry material was stirred under reduced pressure for defoaming, so that the viscosity of the slurry was adjusted to 4,000 mPa·s. The viscosity-adjusted slurry material was formed into a sheet-like compact (thickness: 17 μm) on a PET film through the doctor blade method.

(iii) Firing (Thermal Treatment) Step

A 300 mm square piece was cut out from the sheet-like compact separated from the PET film by means of a cutter, and the piece was crumpled and placed in a sagger made of alumina (dimensions: 90 mm×90 mm×60 mm in height), followed by, under an uncovered condition (i.e., in air), degreasing at 600° C. for two hours and subsequent firing at 900° C. for 12 hours. Thereafter, the temperature was lowered to room temperature at 200 degrees (° C.)/h.

(iv) Crushing and Classification Step

The thus-fired compact, cobbles, and ethanol serving as a dispersion medium were added to a polypot, and wet crushing was carried out until the amount of single-grain particles was 40% or more. The powder particles obtained through pot crushing were wet-sieved for classification.

(v) Thermal Retreatment Step

The power particles obtained through the aforementioned crushing and classification step were thermally treated in air at 650° C. for 24 hours, to thereby produce spinel-type lithium manganate particles having a specific composition and employed as cathode active material particles 22a.

### 3-2. Evaluation Method

### 3-2-1 Measurement of Lattice Strain

The X-ray diffraction pattern of powder was determined by means of “D8 ADVANCE” (a product of Bruker AXS Ltd.) under the following conditions and analyzed according to the WPPD method to calculate the lattice strain of the powder.

X-ray output: 40 kV×40 mA

Goniometer radius: 250 mm

Divergence slit: 0.6°

Scattering slit: 0.6°

Receiving slit: 0.1 mm

Soller slit: 2.5° (incident side, receiving side)

Measurement method: 2θ/θ method in a focusing optical system of horizontally-placed sample type (measured at 2θ of 15 to 140°, step width of 0.01°)

Scanning time: set so that the intensity of main peak ((111) face) becomes about 10,000 counts.

A specific analytical procedure is described below. The values of lattice strain (η) obtained by other analytical procedures may be different from the value of lattice strain (η) obtained by the present analytical procedure, but they are not excluded from the scope of the present invention. In the present invention, evaluation should be carried out by use of the value of lattice strain (η) obtained by the present analytical procedure.

1. Start of software (TOPAS) and load of measured data.
2. Setting of emission profile (selection of Cu tube and Bragg-Brentano type focusing optical system).
3. Setting of background (the Legendre polynomial is used as profile function, and the number of terms is set at 8 to 20).
4. Setting of instrument (fundamental parameter is used, and slit conditions, filament length, and sample length are input).
5. Setting of corrections (sample displacement is used; absorption is also used when the filling density of a sample in a sample holder is low (in this case, absorption is set at the linear absorption coefficient of the sample)).
6. Setting of crystal structure (space group is set at F-d3; lattice constant, crystallite size, and lattice strain are used; and the spread of profile by crystallite size and lattice strain is set as Lorenz function).
7. Calculation (background, sample displacement, diffraction intensity, lattice constant, crystallite size, and lattice strain are made precise).
8. Analysis is terminated when the standard deviation of crystallite size is 6% or less of the crystallite size which has been made precise. When the standard deviation is greater than 6%, the following step 9 is performed.
9. The spread of profile by lattice strain is set as Gauss function (the setting of the crystallite size as Lorenz function is unchanged).
10. Calculation (background, sample displacement, diffraction intensity, lattice constant, crystallite size, and lattice strain are made precise).
11. Analysis is terminated when the standard deviation of crystallite size is 6% or less of the crystallite size which has been made precise. When the standard deviation is greater than 6%, analysis is impossible.
12. The value of lattice strain obtained is multiplied by 11180, and the resultant value is taken as η.

### 3-2-2 Evaluation of Cell Characteristics

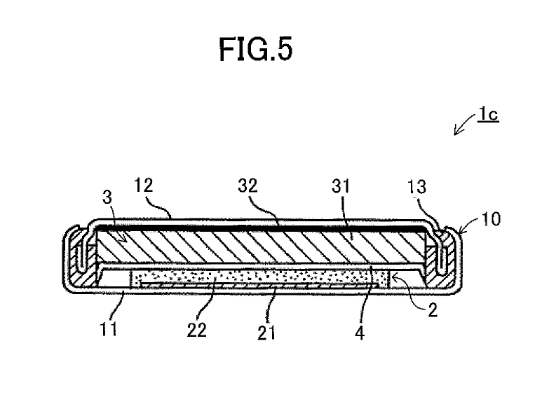

FIG. 5 is a side sectional view of the schematic configuration of a coin cell 1c for evaluating spinel-type lithium manganate particles (cathode active material particles 22a shown in FIG. 3) produced through one embodiment of the production method of the present invention.

The configuration of the coin cell 1c for evaluation use shown in FIG. 5 will next be described. The coin cell 1c was fabricated as follows. A cathode current collector 21, a cathode layer 22, a separator 4, an anode layer 31, and an anode current collector 32 were stacked in this order. The resultant stack and an electrolyte were liquid-tightly sealed in a cell casing 10 (including a cathode container 11, an anode container 12, and an insulation gasket 13).

Specifically, spinel-type lithium manganate particles obtained through the aforementioned production method (cathode active material) (5 mg), acetylene black serving as an electrically conductive agent, and polytetrafluoroethylene (PTFE) serving as a binder were mixed in proportions by mass of 5:5:1, to thereby prepare a cathode material. The thus-prepared cathode material was placed on an aluminum mesh (diameter: 15 mm) and press-formed at 10 kN by means of a pressing machine, to thereby form the cathode layer 22.

The coin cell 1c was fabricated by use of the above-formed cathode layer 22; an electrolytic solution; the anode layer 31 formed of a lithium metal plate; the anode current collector 32 formed of a stainless steel plate; and the separator 4 formed of a lithium ion permeable polyethylene film. The electrolytic solution was prepared as follows: ethylene carbonate (EC) was mixed with an equivolume of diethyl carbonate (DEC) to thereby prepare an organic solvent, and LiPF₆ was dissolved in the organic solvent at a concentration of 1 mol/L.

(A) Initial Capacity (mAh/g)

One cycle consists of the following charge and discharge operations at a test temperature of 20° C.: constant-current charge is carried out at 0.1C rate of current until the cell voltage becomes 4.3 V; subsequently, constant-voltage charge is carried out under a current condition of maintaining the cell voltage at 4.3 V until the current drops to 1120, followed by 10 minutes rest; and then constant-current discharge is carried out at 1C rate of current until the cell voltage becomes 3.0 V, followed by 10 minutes rest. A total of three cycles were performed under a condition of 20° C. The discharge capacity in the third cycle was measured, and the thus-measured capacity was employed as initial capacity.

### (B) Cycle Characteristic (%)

The above-produced cell was subjected to cyclic charge-discharge at a test temperature of 45° C. The cyclic charge-discharge repeats: charge at 1C rate of constant current and constant voltage until 4.3 V is reached, and discharge at 1C rate of constant current until 3.0 V is reached. Cycle characteristic (%) (durability) was defined as a value calculated by dividing the discharge capacity of the cell as measured after 100 repetitions of cyclic charge-discharge by the initial capacity of the cell.

### 3-3. Evaluation Results

(1) Composition Example 1 (No Substitution Element Other than Lithium)

Tables 1 and 2 show the results of experiments in which compositions (no substitution element other than lithium) represented by Li_{1+α}Mn_{2-α}O₄ (typically Li_{1.1}Mn_{1.9}O₄) were produced under different production conditions (Examples 1 to 11 and Comparative Examples 1 to 5) (Table 1 shows production conditions, and Table 2 shows evaluation results). As shown in the column “Raw material type” of Table 1, in Examples 1 to 11 and Comparative Examples 1 to 5, Li₂CO₃ and MnO₂ were employed as main raw material powders (raw material powders of a lithium compound and a manganese compound).

In Table 1, “Particle size” corresponds to median size (D50). “Aid type” and “amount of bonded aid” in the column “Seed crystal” respectively correspond to the presence or absence of a grain growth promoting aid bonded to a seed crystal, and the amount of the aid bonded to the seed crystal. “Total aid amount” is the amount by weight (%) (with respect to a fired compact) of the sum of the amount of a grain growth promoting aid bonded to a seed crystal added, and the amount of a grain growth promoting aid added separately from the seed crystal.

Except for the case of Example 8, the seed crystal employed has the same composition as a final product (i.e., Li_{1.1}Mn_{1.9}O₄). In Example 8, the raw material powder mixture has a composition corresponding to Li_{1.1}Mn_{1.9}O₄, but the seed crystal has a composition different therefrom (i.e., Li_{1.15}Mn_{1.85}O₄). As a result, the final product of Example 8 was found to have a composition of Li₁₁₀₅Mn_{1.895}O₄.

TABLE 1

| | | | Raw material powder mixture | | | | | | | | |
|---|---|---|---|---|---|---|---|---|---|---|---|
| | | | Seed crystal particles | | | | | | | | |
| | | | | | | | Amount | | | | |
| | | | | | | | of | Grain growth | | Total | |
| | Raw material type | | Density | Particle | | | bonded | promoting aid | | aid | |
| | Li | Mn | (particles/ | size | Amount | | aid | | Amount | amount | Forming |
| | compound | compound | cm³) | (μm) | (wt. %) | Aid type | (wt. %) | Aid type | (wt. %) | (wt. %) | step |
| Comp. | Li₂CO₃ | MnO₂ | 0 | | 0 | | | Bi₂O₃ | 1.0 | 1.00 | Done |
| Comp. | Li₂CO₃ | MnO₂ | 5.0 × 10⁷ | 5 | 0.3 | Bi₂O₃ | 2 | Bi₂O₃ | 1.0 | 1.01 | Done |
| Comp. | Li₂CO₃ | MnO₂ | 1.0 × 10¹¹ | 0.08 | 0.003 | None | | Bi₂O₃ | 1.0 | 1.00 | Done |
| Ex. 1 | Li₂CO₃ | MnO₂ | 1.0 × 10⁹ | 3 | 1.4 | None | | None | | 0.00 | Done |
| Ex. 2 | Li₂CO₃ | MnO₂ | 2.0 × 10⁹ | 6 | 23 | Bi₂O₃ | 2 | Bi₂Mn₄O₁₀ | 1.0 | 1.45 | Not |
| Ex. 3 | Li₂CO₃ | MnO₂ | 1.0 × 10⁸ | 5 | 0.7 | Bi₂O₃ | 2 | Bi₂O₃ | 1.0 | 1.01 | Done |
| Ex. 4 | Li₂CO₃ | MnO₂ | 1.0 × 10¹¹ | 0.1 | 0.005 | None | | Bi₂O₃ | 1.0 | 1.00 | Done |
| Ex. 5 | Li₂CO₃ | MnO₂ | 1.5 × 10⁸ | 6 | 1.7 | Bi₂O₃ | 2 | Bi₂O₃ | 1.0 | 1.03 | Done |
| Ex. 6 | Li₂CO₃ | MnO₂ | 2.0 × 10⁹ | 5 | 13 | Bi₂Mn₄O₁₀ | 3 | Bi₂Mn₄O₁₀ | 1.0 | 1.39 | Done |
| Ex. 7 | Li₂CO₃ | MnO₂ | 2.4 × 10¹⁰ | 2 | 10 | Bi₂O₃ | 2 | Bi₂Mn₄O₁₀ | 1.0 | 1.20 | Done |
| Ex. 8 | Li₂CO₃ | MnO₂ | 2.4 × 10¹⁰ | 2 | 10 | Bi₂O₃ | 2 | Bi₂Mn₄O₁₀ | 1.0 | 1.20 | Done |
| Ex. 9 | Li₂CO₃ | MnO₂ | 3.0 × 10⁹ | 5 | 20 | Bi₂Mn₄O₁₀ | 5 | None | | 0.98 | Done |
| Ex. 10 | Li₂CO₃ | MnO₂ | 1.0 × 10¹¹ | 1 | 5 | None | | Bi₂O₃ | 1.0 | 1.00 | Done |
| Ex. 11 | Li₂CO₃ | MnO₂ | 1.0 × 10⁸ | 10 | 5 | Bi₂Mn₄O₁₀ | 1 | Bi₂O₃ | 1.0 | 1.05 | Done |
| Comp. | Li₂CO₃ | MnO₂ | 1.5 × 10¹¹ | 2 | 30 | Bi₂O₃ | 2 | Bi₂O₃ | 1.0 | 1.60 | Done |
| Comp. | Li₂CO₃ | MnO₂ | 1.0 × 10⁸ | 12 | 9 | Bi₂Mn₄O₁₀ | 1 | Bi₂O₃ | 1.0 | 1.09 | Done |

TABLE 2

Cell characteristics

| | | | Cycle |
|---|---|---|---|
| | | Initial capacity | characteristic |
| | Lattice strain | (mAh/g) | (%) |
| Comp. Ex. 1 | 2.0 × 10⁻³ | 104 | 86 |
| Comp. Ex. 2 | 1.0 × 10⁻³ | 104 | 87 |
| Comp. Ex. 3 | 1.0 × 10⁻³ | 104 | 88 |
| Ex. 1 | 8.0 × 10⁻⁴ | 104 | 91 |
| Ex. 2 | 7.0 × 10⁻⁴ | 104 | 92 |
| Ex. 3 | 3.0 × 10⁻⁴ | 104 | 93 |
| Ex. 4 | 8.0 × 10⁻⁴ | 104 | 91 |
| Ex. 5 | 2.0 × 10⁻⁴ | 104 | 94 |
| Ex. 6 | 2.0 × 10⁻⁴ | 104 | 94 |
| Ex. 7 | 3.0 × 10⁻⁴ | 104 | 94 |
| Ex. 8 | 3.0 × 10⁻⁴ | 103 | 94 |
| Ex. 9 | 3.0 × 10⁻⁴ | 104 | 94 |
| Ex. 10 | 8.0 × 10⁻⁴ | 104 | 91 |
| Ex. 11 | 7.0 × 10⁻⁴ | 104 | 92 |
| Comp. Ex. 4 | 3.0 × 10⁻³ | 104 | 82 |
| Comp. Ex. 5 | 2.0 × 10⁻³ | 104 | 86 |

As shown in Tables 1 and 2, in the case of Comparative Example 1 (no addition of a seed crystal), Comparative Example 2 (addition of a small amount of a seed crystal), or Comparative Example 3 (addition of a seed crystal having a very small particle size), favorable cycle characteristic failed to be attained. Similarly, in the case of Comparative Example 4 (addition of a very large amount of a seed crystal) or Comparative Example 5 (addition of a seed crystal having a very large particle size), favorable cycle characteristic failed to be attained. Conceivably, this is attributed to the fact that the resultant fired compact had a microstructure as shown in FIG. 4B; i.e., a bimodal structure including large-sized grains and fine grains, and thus a large amount of energy was required for crushing of the compact, resulting in deterioration of lattice strain.

In contrast, in the cases of Examples 1 to 11 (addition of a seed crystal having an intended particle size in an intended amount), favorable cycle characteristic was attained. Conceivably, this is attributed to the fact that since grain growth started from uniformly dispersed seed crystal particles, the resultant fired compact had a microstructure as shown in FIG. 4A; i.e., a microstructure including large-sized crystal grains having uniform size, and thus the fired compact was readily crushed, resulting in no deterioration of lattice strain. Even in the case of Example 8 (i.e., the composition of the seed crystal was not the same as that of a final product), the resultant particles exhibited favorable characteristics. However, in the case of Example 2 (no forming step) or Example 4 or 10 (the seed crystal was added in a maximum amount), lattice strain was somewhat increased.

In the case where a grain growth promoting aid was added; specifically, the case where a grain growth promoting aid was bonded to a seed crystal and also added separately from the seed crystal (Example 2, 3, 5, 6, 7, 8, or 11), the case where a grain growth promoting aid was not bonded to a seed crystal (Example 4 or 10), and the case where a grain growth promoting aid was only added in the form of being bonded to a seed crystal (Example 9), the resultant particles exhibited favorable characteristics. However, in the case of Example 1 (no addition of a grain growth promoting aid), lattice strain was somewhat increased. Conceivably, this is attributed to an increase in number of fine grains.

### (2) Composition Example 2 (Substitution by Al)

Tables 3 and 4 show the results of evaluations which were performed in a manner similar to that described above on a composition of LiMₓMn₂₋ₓO₄ (wherein M is Al; specifically Li_{1.08}Al_{0.09}Mn_{1.83}O₄). Except for the case of Example 19, the seed crystal employed has the same composition as a final product (i.e., Li_{1.08}Al_{0.09}Mn_{1.83}O₄). In Example 19, the raw material powder mixture has a composition corresponding to Li_{1.08}Al_{0.09}Mn_{1.83}O₄, but the seed crystal has a composition different therefrom (i.e., Li_{1.1}Mn_{1.9}O₄). As shown in Tables 3 and 4, in Composition Example 2, results similar to those described above in Composition Example 1 were obtained.

TABLE 3

| | | | | Raw material powder mixture | | | | | | | | |
|---|---|---|---|---|---|---|---|---|---|---|---|---|
| | | | | Seed crystal particles | | | | | Grain growth | | | |
| | | | | | | | | Amount of | promoting aid | | | |
| | Raw material type | | | Density | Particle | | | bonded | | Amount | Total aid | |
| | Li | Mn | Al | (particles/ | size | Amount | | aid | | (wt. | amount | Forming |
| | compound | compound | compound | cm³) | (μm) | (wt. %) | Aid type | (wt. %) | Aid type | %) | (wt. %) | step |
| Comp. Ex. | Li₂CO₃ | MnO₂ | Al(OH)₃ | 0 | | 0 | | | Bi₂O₃ | 1.0 | 1.00 | Done |
| Comp. Ex. | Li₂CO₃ | MnO₂ | Al(OH)₃ | 8.0 × 10⁷ | 10 | 4.2 | Bi₂O₃ | 3 | Bi₂O₃ | 1.0 | 1.13 | Done |
| Comp. Ex. | Li₂CO₃ | MnO₂ | Al(OH)₃ | 1.0 × 10¹¹ | 0.0 | 0.003 | None | | Bi₂O₃ | 1.0 | 1.00 | Done |
| Ex. 12 | Li₂CO₃ | MnO₂ | Al(OH)₃ | 1.0 × 10⁹ | 3 | 1.4 | None | | None | | 0.00 | Done |
| Ex. 13 | Li₂CO₃ | MnO₂ | Al(OH)₃ | 2.0 × 10⁹ | 6 | 23 | Bi₂O₃ | 2 | Bi₂Mn₄O₁ | 1.0 | 1.45 | Not |
| Ex. 14 | Li₂CO₃ | MnO₂ | Al(OH)₃ | 1.0 × 10⁸ | 5 | 0.7 | Bi₂O₃ | 2 | Bi₂O₃ | 1.0 | 1.01 | Done |
| Ex. 15 | Li₂CO₃ | MnO₂ | Al(OH)₃ | 1.0 × 10¹¹ | 0.1 | 0.005 | None | | Bi₂O₃ | 1.0 | 1.00 | Done |
| Ex. 16 | Li₂CO₃ | MnO₂ | Al(OH)₃ | 1.5 × 10⁸ | 6 | 1.7 | Bi₂O₃ | 2 | Bi₂O₃ | 1.0 | 1.03 | Done |
| Ex. 17 | Li₂CO₃ | MnO₂ | Al(OH)₃ | 2.0 × 10⁹ | 5 | 13 | Bi₂Mn₄O₁₀ | 3 | Bi₂Mn₄O₁ | 1.0 | 1.39 | Done |
| Ex. 18 | Li₂CO₃ | MnO₂ | Al(OH)₃ | 2.4 × 10¹⁰ | 2 | 10 | None | | Bi₂Mn₄O₁ | 1.0 | 1.00 | Done |
| Ex. 19 | Li₂CO₃ | MnO₂ | Al(OH)₃ | 1.5 × 10⁸ | 1 | 0.008 | None | | Bi₂O₃ | 1.0 | 1.00 | Done |
| Ex. 20 | Li₂CO₃ | MnO₂ | Al(OH)₃ | 3.0 × 10⁹ | 5 | 20 | Bi₂O₃ | 6 | None | | 1.18 | Done |
| Ex. 21 | Li₂CO₃ | MnO₂ | Al(OH)₃ | 1.0 × 10¹¹ | 1 | 5 | None | | Bi₂O₃ | 1.0 | 1.00 | Done |
| Ex. 22 | Li₂CO₃ | MnO₂ | Al(OH)₃ | 1.0 × 10⁸ | 10 | 5 | Bi₂Mn₄O₁₀ | 1 | Bi₂O₃ | 1.0 | 1.05 | Done |
| Comp. Ex. | Li₂CO₃ | MnO₂ | Al(OH)₃ | 1.5 × 10¹¹ | 2 | 27 | None | | Bi₂O₃ | 1.0 | 1.00 | Done |
| Comp. Ex. | Li₂CO₃ | MnO₂ | Al(OH)₃ | 1.0 × 10⁸ | 12 | 9 | Bi₂Mn₄O₁₀ | 1 | Bi₂O₃ | 1.0 | 1.09 | Done |

TABLE 4

Cell characteristics

| | | Initial | Cycle |
|---|---|---|---|
| | | capacity | characteristic |
| | Lattice strain | (mAh/g) | (%) |
| Comp. Ex. 6 | 2.0 × 10⁻³ | 104 | 88 |
| Comp. Ex. 7 | 1.0 × 10⁻³ | 104 | 88 |
| Comp. Ex. 8 | 1.0 × 10⁻³ | 104 | 89 |
| Ex. 12 | 9.0 × 10⁻⁴ | 104 | 92 |
| Ex. 13 | 8.0 × 10⁻⁴ | 104 | 93 |
| Ex. 14 | 4.0 × 10⁻⁴ | 104 | 96 |
| Ex. 15 | 8.0 × 10⁻⁴ | 104 | 92 |
| Ex. 16 | 3.0 × 10⁻⁴ | 104 | 98 |
| Ex. 17 | 3.0 × 10⁻⁴ | 104 | 98 |
| Ex. 18 | 4.0 × 10⁻⁴ | 104 | 97 |
| Ex. 19 | 4.0 × 10⁻⁴ | 104 | 97 |
| Ex. 20 | 3.0 × 10⁻⁴ | 104 | 98 |
| Ex. 21 | 9.0 × 10⁻⁴ | 104 | 94 |
| Ex. 22 | 5.0 × 10⁻⁴ | 104 | 92 |
| Comp. Ex. 9 | 3.0 × 10⁻³ | 104 | 81 |
| Comp. Ex. 10 | 2.0 × 10⁻³ | 104 | 88 |

### (3) Composition Example 3 (Substitution by Ni)

Tables 5 and 6 show the results of evaluations which were performed in a manner similar to that described above on a composition of LiMₓMn₂₋ₓO₄ (wherein M is Ni; specifically Li_{1.01}Ni_{0.46}Mn_{1.53}O₄). Li₂CO₃, MnO₂, and MO were employed as main raw material powders. In this example, a cell for evaluation was fabricated according to the procedure described in the literature (Electrochemical and Solid-State Letters, 9 (4) A203-A206 (2006)). As shown in Tables 5 and 6, in Composition Example 3, results similar to those described above in Composition Example 1 or 2 were obtained.

TABLE 5

| | Raw material powder mixture | | | | | | | | |
|---|---|---|---|---|---|---|---|---|---|
| | Seed crystal particles | | | | | | | | |
| | | | | | Amount | | | | |
| | | | | | of | Grain growth | | Total | |
| | | | | | bonded | promoting aid | | aid | |
| | Density | Particle | Amount | | aid | | Amount | amount | |
| | (particles/ | size | (wt. | Aid | (wt. | | (wt. | (wt. | Forming |
| | cm³) | (μm) | %) | type | %) | Aid type | %) | %) | step |
| Ex. 23 | 1.5 × 10⁸ | 5 | 1 | Bi₂Mn₄O₁ | 2 | Bi₂O₃ | 1.0 | 1.02 | Done |
| Ex. 24 | 2.0 × 10⁹ | 5 | 13 | Bi₂O₃ | 2 | Bi₂O₃ | 1.0 | 1.26 | Done |
| Ex. 25 | 2.4 × 10¹⁰ | 2.5 | 20 | None | | Bi₂O₃ | 1.0 | 1.00 | Done |

TABLE 6

Cell characteristics

| | | Initial capacity | Cycle |
|---|---|---|---|
| | Lattice strain | (mAh/g) | characteristic (%) |
| Ex. 23 | 3.0 × 10⁻⁴ | 130 | 94 |
| Ex. 24 | 3.0 × 10⁻⁴ | 130 | 95 |
| Ex. 25 | 7.0 × 10⁻⁴ | 130 | 93 |

### 3. Modifications

The above-described embodiment and specific examples are, as mentioned above, mere examples of the best mode of the present invention which the applicant of the present invention contemplated at the time of filing the present application. The above-described embodiment and specific examples should not be construed as limiting the invention. Various modifications to the above-described embodiment and specific examples are possible, so long as the invention is not modified in essence.

Several modifications will next be exemplified. Needless to say, even modifications are not limited to those described below. Limitingly construing the present invention based on the above-described embodiment and the following modifications impairs the interests of an applicant (particularly, an applicant who is motivated to file as quickly as possible under the first-to-file system) while unfairly benefiting imitators, and is thus impermissible.

Needless to say, the constitution of the above-described embodiment and the constitutions of the modifications to be described below are entirely or partially applicable in appropriate combination, so long as no technical inconsistencies are involved.

(1) The present invention is not limited to the constitution which is specifically disclosed in the description of the above embodiments. That is, the application of the present invention is not limited to the specific configurations shown in FIGS. 1, 2, and 5. Also, no particular limitation is imposed on the number of the cathode plates 2, the separators 4, and the anode plates 3 to be stacked together.

(2) The present invention is not limited to the production methods disclosed specifically in the above-described embodiments. For example, the firing step may be performed by means of a rotary kiln. In this case, when a grain growth promoting aid is added, a component of the aid (e.g., bismuth) is removed more efficiently.

The aforementioned thermal retreatment step may also serve as a lithium incorporation step. That is, a lithium compound may be added not before the forming step, but in the thermal retreatment step. In this case, the thermal treatment temperature in the lithium incorporation step is preferably 500° C. to 800° C.

Specifically, lithium manganate may be produced through, for example, the following procedure: a powder mixture of manganese oxide and alumina is (formed into a compact) and fired, and then a lithium compound is added to the fired compact, followed by further firing. Alternatively, lithium manganate may be produced by forming lithium manganate crystals having high lithium content, and then adding manganese oxide or alumina to the crystals, followed by further firing.

The thermal retreatment step may be omitted when the temperature drop rate is low (e.g., about 20 degrees (° C.)/h) after firing, or when the fired compact is maintained at a temperature (e.g., 600 to 700° C.) for a specific period of time during temperature drop.

(3) Needless to say, those modifications which are not particularly referred to are also encompassed in the technical scope of the present invention, so long as the invention is not modified in essence.

Those components which partially constitute means for solving the problems to be solved by the present invention and are operationally or functionally expressed encompass not only the specific structures disclosed above in the description of the aforementioned embodiments and modifications but also any other structures that can implement the operations or functions of the components. Further, the contents (including specifications and drawings) of the prior application and publications cited herein can be incorporated herein as appropriate by reference.

1. A method for producing spinel-type lithium manganate, which is an oxide containing at least lithium and manganese as constituent elements and having a spinel structure, characterized in that the method comprises:
a raw material preparation step of preparing a raw material mixture;
a firing step of firing the raw material mixture prepared through the raw material preparation step; and
a crushing step of crushing the fired compact obtained through the firing step, wherein the raw material mixture contains a main raw material containing at least a manganese compound, and a seed crystal having a spinel-type crystal structure.

2. A method for producing spinel-type lithium manganate according to claim 1, wherein the seed crystal has a median particle size of 0.1 to 10 μm.

3. A method for producing spinel-type lithium manganate according to claim 1, wherein the seed crystal has a density of 1×108 to 1×1011 particles/cm³ fired compact.

4. A method for producing spinel-type lithium manganate according to claim 1, wherein the amount of the seed crystal added is 25 wt. % or less with respect to the fired compact.

5. A method for producing spinel-type lithium manganate according to claim 1, wherein the raw material mixture further contains a grain growth promoting aid having a melting point lower than the firing temperature employed in the firing step.

6. A method for producing spinel-type lithium manganate according to claim 5, wherein the amount of the grain growth promoting aid added is 5 wt. % or less with respect to the fired compact.

7. A method for producing spinel-type lithium manganate according to claim 1, wherein the main raw material contains a lithium compound and a manganese compound.

8. A method for producing spinel-type lithium manganate according to claim 1, which further comprises a forming step of forming the raw material mixture into a thin compact before the firing step is carried out.
